(19) United States
(12) Patent Application Publication
(10) Pub. No.: US 2017/0155928 A1
(43) Pub. Date: Jun. 1, 2017

(54) Method, Device and System for Playing Live Video

(71) Applicants: Le Holdings (Beijing) Co., Ltd., Beijing (CN); LeClouud Computing Co., Ltd., Beijing (CN)

(72) Inventor: Lizhi Wei, Beijing (CN)

(21) Appl. No.: 15/245,387

(22) Filed: Aug. 24, 2016

Related U.S. Application Data
(63) Continuation of application No. PCT/CN2016/082817, filed on May 20, 2016.

(30) Foreign Application Priority Data
Nov. 26, 2015 (CN) 201510845810.1

(51) Int. Cl. H04N 21/2187; H04N 21/234; H04N 21/235; H04N 21/24; H04N 21/45; H04N 21/4627; H04N 21/442; H04L 29/06; H04N 21/472

(52) U.S. Cl. CPC H04N 21/2187; H04L 67/42; H04N 21/234; H04N 21/235; H04N 21/472; H04N 21/4532; H04N 21/4627; H04N 21/44209; H04N 21/2402; H04L 67/142

(57) ABSTRACT

The present disclosure provides a method, a device and a system for playing live video. The technical solutions employed by embodiments of the present disclosure include: receiving, by an edge server, a play request from a client requesting to view live video, wherein the edge server is a node server in a content delivery network system which provides data transmission service to the client; sending the play request to a control center, so that the control center configures data download path information according to the play request; receiving, from the control center, the data download path information; obtaining live video data corresponding to the play request from a live broadcasting platform according to the data download path information; and sending the live video data to the client so that the client can play the live video.

### CROSS REFERENCE TO RELATED APPLICATIONS

This application is a continuation of International Application No. PCT/CN2016/082817, filed on May 20, 2016, which is based upon and claims priority to Chinese Patent Application No. 201510845810.1, filed on Nov. 26, 2015, the entire contents of which are incorporated herein by reference.

### TECHNICAL FIELD

The present disclosure generally relates to the computer technical field, and more particularly to a method, a device and a system for playing live video.

### BACKGROUND

By adding a new network architecture layer into existing Internet, Content Delivery Networks (CDN) can deliver contents of a website to a network “edge” which is closest to clients, so that users can obtain desired contents via a nearby network. Such technology can reduce network congestion of Internet and increase response speed when users access websites. The CDN network architecture mainly includes two parts, i.e., a center part and an edge part. The center part refers to a CDN network management center and a DNS redirection and parsing center, and is responsible for overall load balancing. The device system of center part is mounted in the network management center machine. The edge part, which is carrier for delivering in CDN, mainly refers to allopatric nodes, and is generally made up of caches, load balancers, and the like.

Live video broadcast refers to broadcasting live videos via Internet and streaming media technologies. With integration of rich elements such as images, texts, and sounds, and capability of providing good communication effects (such as sounds or facial expressions) instantly, live video broadcast has become a mainstream expression way in Internet field. By transmitting data in a real and vivid way, video can offer participatory experiences and attract attentions, and thus present an impressive and memorable dissemination effect. At present, when playing live video via CDN networks, the edge sever will process the request which was initiated by a user requesting to view live video, obtains live video data from a live broadcasting platform according to a download path configured by the edge server and sends the live video data to the client used by the requesting user. Consequently, users can view the live video online. Live video broadcast requires a high real time performance, which means that the video play path needs to have a good transmission performance. In prior live video play technologies, the play path which is preset is determined by the edge server, and download and play of live video are performed according to the locally configured fixed path. The play path is single and fixed, and thus if a certain node in the transmission path has a failure, manual amendments for the configuration policy or configuration script of the play path in the edge server are needed in order to bypass the failed node. Obviously, such method is not applicable for download and play of live video data which requires relatively high real time performance.

### SUMMARY

The present disclosure provides a method, a device and a system for playing live video which are capable of solving the problem that the live video play path is single and fixed and has a low intelligence.

In order to achieve the above objectives, the present disclosure provides the following technical solutions.

In a first aspect, embodiments of the present disclosure provide a method for playing live video, including:

receiving, by an edge server, a play request from a client requesting to view live video, wherein the edge server is a node server in a CDN system which provides data transmission service to the client;

sending the play request to a control center, so that the control center configures data download path information according to the play request, wherein the control center is configured to monitor data transmission status of all node servers in the CDN system;

receiving, from the control center, the data download path information indicating a data transmission path made up of node servers and calculated in real time by the control center according to a preset path configuration policy;

obtaining live video data corresponding to the play request from a live broadcasting platform according to the data download path information; and

sending the live video data to the client to enable the client to play the live video.

In a second aspect, embodiments of the present disclosure provide an electronic device, including:

at least one processor; and

a memory communicably connected with the at least one processor for storing instructions executable by the at least one processor, wherein execution of the instructions by the at least one processor causes the at least one processor to:

receive a play request from a client requesting to view live video, wherein the edge server is a node server in a CDN system which provides data transmission service to the client;

send the play request to a control center, so that the control center configures data download path information according to the play request, wherein the control center is configured to monitor data transmission status of all node servers in the CDN system;

receive, from the control center, the data download path information indicating a data transmission path made up of node servers and calculated in real time by the control center according to a preset path configuration policy;

obtain live video data corresponding to the play request from a live broadcasting platform according to the data download path information; and

send the obtained live video data to the client so that the client plays the live video.

In a third aspect, embodiments of the present disclosure provide an electronic device, including:

at least one processor; and

a memory communicably connected with the at least one processor for storing instructions executable by the at least one processor, wherein execution of the instructions by the at least one processor causes the at least one processor to:

receive a play request for playing live video sent from an edge server, wherein the play request is a live video play request sent from a client requesting to view the live video to the edge server;

in response to the play request, calculate in real time data download path information according to a preset path configuration policy, wherein the download path information indicates a data transmission path made up of node servers; and

send the calculated data download path information to the edge server.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart illustrating a method for playing live video in accordance with some embodiments;

FIG. 2 is a flowchart illustrating a method for playing live video in accordance with some embodiments;

FIG. 3 is a flowchart illustrating a method for playing live video in accordance with some embodiments;

FIG. 4 is a block diagram illustrating a structure of a device for playing live video in accordance with some embodiments;

FIG. 5 is a block diagram illustrating a structure of a device for playing live video in accordance with some embodiments;

FIG. 6 is a block diagram illustrating a structure of a device for playing live video in accordance with some embodiments;

FIG. 7 is a block diagram illustrating a structure of a device for playing live video in accordance with some embodiments;

FIG. 8 is a block diagram illustrating a system for playing live video in accordance with some embodiments;

FIG. 9 is a block diagram illustrating a device for playing live video in accordance with some embodiments; and

FIG. 10 is a block diagram illustrating an electronic device in accordance with some embodiments.

### DETAILED DESCRIPTION

In order to make objectives, technical solutions and advantages of embodiments of the present disclosure more clear, technical solutions in embodiments of the present disclosure will be described clearly and completely with reference to drawings of embodiments of the present disclosure. It should be noted that the following embodiments are illustrative only, rather than limiting the scope of the disclosure.

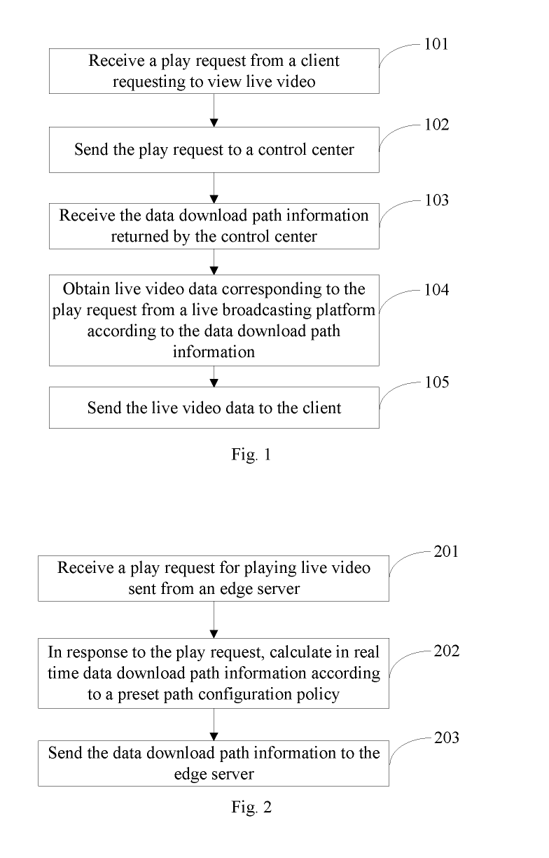

Embodiments of the present disclosure provide a method for playing live video. As shown in FIG. 1, the method can be applied in an edge server of a CDN system. Specifically, the method can include the following steps.

In step 101, the edge server receives a play request from a client requesting to view live video.

If a user wants to view a live video, he/she needs to select the link to the video on a webpage, i.e., to send a play request for playing the desired video to a server. The server receiving the play request in the CDN system is called as an edge server which serves as a user-facing window of the CDN system. Depending on system settings, users at different geographical areas or served by different networks correspond to one or more edge servers which provide services for the users. Thus, edge servers provide services to relatively fixed objects, and the data transmission performance between edge servers and clients used by the users is relatively good. If there are more than one edge servers available for providing services to a user, the play request is generally sent to an edge server having the lowest load.

In 102, the edge server sends the play request to a control center.

After receiving the play request from the client, the edge server sends the play request to a control center for processing. The control center configures an optimal data download path according to the current data transmission status in the network and returns the optimal data download path to the edge server. The control center in embodiments of the present disclosure may be a server in a relay device layer of the CDN system which is capable of monitoring data transmission status of all node servers in the CDN system and determining current operation status and load condition of respective node servers according to the data transmission status. As compared with prior technologies in which an edge server locally configures a data download path in response to a play request, embodiments of the present disclosure can dynamically configure path information to bypass currently failed nodes in the network. Also, the edge server can use the saved process resources to perform other operations, for it does not need to configure a data download path anymore, for example, receiving live video data uploaded by users or receiving play requests from other users or anything else. Thus, the processing efficiency of edge server would be increased.

In 103, the edge server receives the data download path information returned by the control center.

The control center sends the data download path information to the edge server as response information in reply to the play request. The download path information is indicating a data transmission path originating from a server storing live video data to the edge server and calculated in real time by the control center according to a preset path configuration policy. The path is made up of a plurality of node servers in the CDN system. The control center selects a transmission path having the highest transmission efficiency and relatively short distance according to a preset policy to improve fluency when users view live video.

In 104, the edge server obtains live video data corresponding to the play request from a live broadcasting platform according to the data download path information.

After obtaining the data download path information, the edge server sends the user's play request to a server storing the live video data along the configured path, and then the server sends the live video data along the same path to the edge server.

Alternatively, the control center sends the play request and the data download path information to the server storing the live video data, and the server directly sends corresponding live video data to the edge server along the configured path.

In 105, the edge server sends the live video data to the client.

The edge server sends the obtained live video data to the client in response to the play request sent from the client. The client plays the live video according to the received data.

Corresponding to the above method, embodiments of the present disclosure further provide a method for playing live video. As shown in FIG. 2, the method is applied in a control center in a CDN system. Specifically, the method can include the following steps.

In 201, the control center receives a play request for playing live video sent from an edge server.

The control center in embodiments of the present disclosure can be located in an edge server or a relay device layer of the system, and embodiments of the present disclosure do not impose specific limitations on this. The servers in the relay device layer have better data transmission performance with all edge servers in the system, and thus in many cases the control center is located in a server in the relay device layer to receive and process live video play requests sent from edge servers.

In 202, in response to the play request, the control center calculates data download path information in real time according to a preset path configuration policy.

After receiving the live video play request, the control center, according to a preset path configuration policy, configures a transmission path having the highest transmission speed and consisting of a plurality of node servers in the CDN system. The preset path configuration policy is a configuration policy set by an administrator according to specific configuration conditions of the live broadcasting platform and the edge servers. By monitoring current data transmission performance of respective node servers in the CDN system, the control center can calculate a path of the highest data transmission speed from a server storing the requested live video data in the live broadcasting platform to the edge server which sent the play request. Further, the policy can also take factors such as distance, different regions or different operators the path will pass by and the like into account comprehensively for planning the path, thereby obtaining an optimal path with good balance of transmission speed and costs. The sampling and calculation of these parameters occupy a lot of process resources, and therefore, the processing stress of the edge server can be reduced by stripping the path planning function out from it. And the path planning functions of the whole system are concentrated in the control center for performing configuration and calculation of the path from the live broadcasting platform to respective edge servers.

In 203, the control center sends the data download path information to the edge server.

After calculating the optimal data download path in response to the play request, the control center sends the obtained data download path information to the edge server as a response to the play request sent from the edge server.

As can be seen from the above implementations, in the method for playing live video provided by embodiments of the present disclosure, an edge server receives a play request from a client requesting to view live video, and sends the request to a control center; the control center, in response to the play request, configures information of a path for downloading live video data according to the current status of the whole CDN system, and sends the data download path information back to the edge server; and the edge server obtains corresponding live video data from a live broadcasting platform along the path specified by the data download path information and forwards the live video data to the client for play. As compared with prior methods for playing live video, the data transmission path calculated by using the play methods in embodiments of the present disclosure is a dynamic path depending on the data transmission status of the whole CDN system, instead of a fixed one in the edge server. Thus, the technical solutions in the present disclosure can effectively avoid congested or failed nodes in the network, thereby making play of live video more fluently. Also, if policy amendments are needed for configuring paths, the policy adjustments only need to be performed in the control center, and the steps of amending path configuration files in respective edge servers can be omitted. As a result, the configuration procedure is simplified, and thereby the response efficiency of the path configuration can be improved.

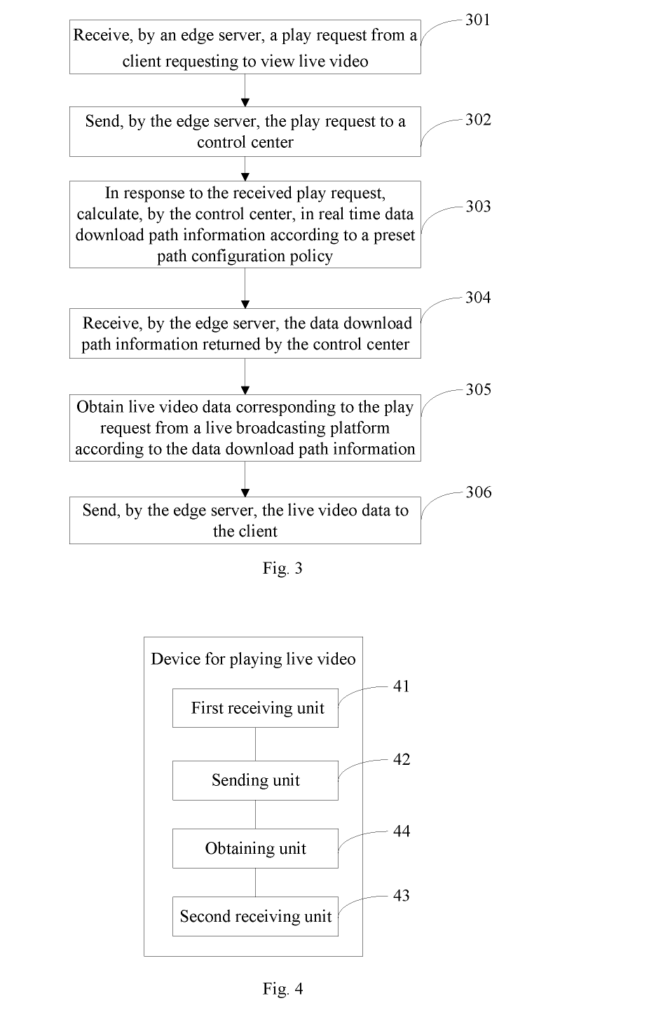

In order to describe the method for playing live video descripted by embodiments of the present disclosure in further detail, the following description will combine the above two methods. As shown in FIG. 3, the method includes the following specific steps.

In 301, an edge server receives a play request from a client requesting to view live video.

Edge servers are distributed in the CDN system so that users in different geographical areas or served by different operators can send play requests to different edge servers. Edge servers can forward a part of users' requests to other edge servers for processing according to processing capacities of themselves by using load balancing system in the CDN system. From a user perspective, this step corresponds to selecting a desired channel or live video in a live broadcasting platform.

In 302, the edge server sends the play request to a control center.

After receiving the play request from the client, the edge server sends the play request to a control center. Also, before sending, the edge server can add the address information of the edge server itself into the play request, so that the control center can determine which edge server sends the play request. And the address of the edge server can also be determined as the end address of the data download path. The address information of the edge server can be an IP address of the node. A download path request, which includes the IP address and the play request, will be sent to the control center for calculating a path for downloading live video data for the client.

In 303, the control center calculates in real time data download path information according to the received play request and a preset upload path configuration policy.

After receiving the play request sent from the edge server, the control center can parse the play request to obtain the address information of the edge server and the play request sent from the client, and extracts user information of the client according to the play request. The contents of the user information can include user name, the IP address of the user, and the like. By identifying and verifying the user information, the control center can determine whether the client has a permission to view the requested live video. For example, the control center can determine whether the user is a registered user in the live broadcasting platform, whether the money in the registered account of the user is enough to pay for the live video, and so on. After confirming that the user has the permission to view the live video, the control center performs path planning according to a preset path configuration policy. Specific policy can be set by an administrator according to actual requirements, and embodiments of the present disclosure do not impose specific limitations on this. The main goal of the policy is to configure a data transmission path having high data transmission speed and low costs. For example, the control center determines which nodes are available according to data transmission status of respective node servers, and then determine a transmission path using the available nodes. Respective nodes belong to the same operator can be selected and the number of the selected nodes can be as small as possible so as to reduce cost for data transmission.

The control center may determine the data transmission status of respective node servers in the system by sending keepalive packets to node servers in the CDN system. For example, the control center periodically sends messages to the node servers and receives response messages from them.

The data download path calculated according to the preset policy can be made up of node servers in the CDN system. Thus, the data download path information can be represented by an IP address list in which IP addresses of node servers which the path passes through are listed in order, an origin node address in the node address list is the address of a source server in the live broadcasting platform storing the live video, an end node address is the address of the edge server which sends the play request, and the middle node addresses are the addresses of those node servers having high data transmission speed. By the node address list, the live video data can be delivered to the edge server quickly.

Further, in order to send the node address list to the edge server, the node address list can be compressed to obtain the compressed data download path information.

In 304, the edge server receives the data download path information returned by the control center.

After receiving the data download path information obtained in 303, the edge server parses the data download path information according to the specific format of the data download path information to obtain the node address list.

In 305, the edge server obtains live video data corresponding to the play request from the live broadcasting platform according to the data download path information.

According to the node address list obtained in 304, the edge server finds a preceding node server adjacent to the edger server in the path, and sends the play request along with the data download path information to the node server according to the IP address of the node server; then, the node server finds a preceding node server according to the obtained node address list, and so on, until the play request is sent to the origin node address in the node address list, i.e., to the source server storing the live video data in the live broadcasting platform. The source server sends the corresponding live video data back to the edge server along the same transmission path configured for the play request.

In 306, the edge server sends the live video data to the client.

From a user perspective, the sending of live video data from the edge server to the client of the user is a response to the channel or live video selected by the client in 301, and then the client can play the live video according to the received data.

Further, embodiments of the present disclosure provide a device for playing live video to implement the above methods. The device may be provided in a resource server in a CDN system. As shown in FIG. 4, the device can include a first receiving unit 41, a sending unit 42, a second receiving unit 43, and an obtaining unit 44.

The first receiving unit 41 is configured to receive, in an edge server, a play request from a client requesting to view live video, wherein the edge server is a node server in a CDN system which provides data transmission service to the client.

The sending unit 42 is configured to send the play request received by the first receiving unit 41 to a control center, so that the control center configures data download path information according to the play request, wherein the control center is configured to monitor data transmission status of all node servers in the CDN system.

The second receiving unit 43 is configured to receive, from the control center, the data download path information indicating a high speed data transmission path made up of node servers and calculated in real time by the control center according to a preset path configuration policy. The receiving unit and the first receiving unit 41 may be implemented as the same physical unit, but embodiments of the present disclosure are not limited to this.

The obtaining unit 44 is configured to obtain live video data corresponding to the play request from a live broadcasting platform according to the data download path information received by the second receiving unit 43.

The sending unit 42 is further configured to send the live video data obtained by the obtaining unit 44 to the client so that the client can play the live video.

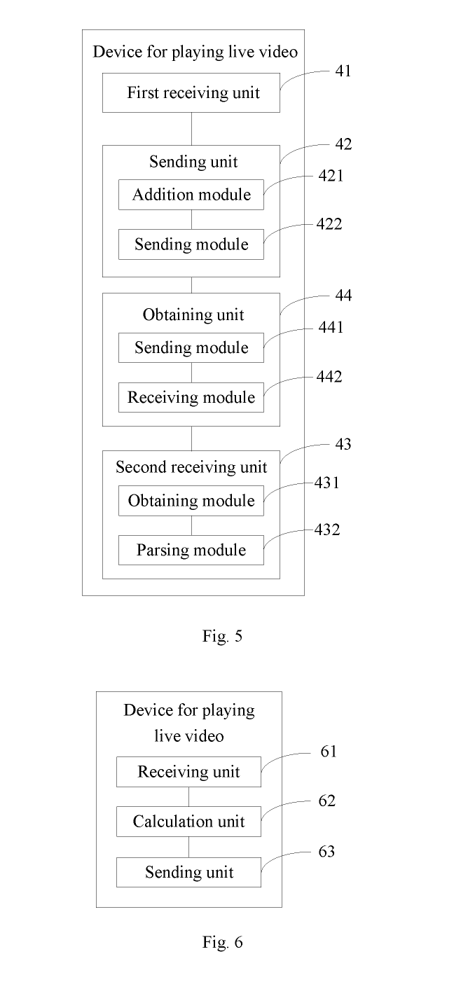

Further, as shown in FIG. 5, the sending unit 42 can include an addition module 421 and a sending module 422.

The addition module 421 is configured to add address information of the edge server into the play request to generate a download path request.

The sending module 422 is configured to send the download path request generated by the addition module 421 to the control center.

Further, as shown in FIG. 5, the second receiving unit 43 can include an obtaining module 431 and a parsing module 432.

The obtaining module 431 is configured to obtain the download path information configured by the control center according to the download path request.

The parsing module 432 is configured to parse the download path information obtained by the obtaining module 431 to obtain a node address list in which address information of respective node servers in a path for transmitting the live video data are listed.

Further, as shown in FIG. 5, the obtaining unit 44 can include a sending module 441 and a receiving module 442.

The sending module 441 is configured to send the download path information and the play request to the live broadcasting platform, so that the live broadcasting platform searches corresponding live video data according to the play request and transmits the live video data along the path configured in the download path information.

The receiving module 442 is configured to receive the live video data sent from the live broadcasting platform.

Further, embodiments of the present disclosure provide a device for playing live video. The device may be provided in a control center in a CDN system. As shown in FIG. 6, the device can include a receiving unit 61, a calculation unit 62 and a sending unit 63.

The receiving unit 61 is configured to receive, in the control center, a play request for playing live video sent from an edge server, wherein the play request is a live video play request sent from a client requesting to view the live video to the edge server.

The calculation unit 62 is configured to, in response to the play request received by the receiving unit 61, calculate in real time data download path information according to a preset path configuration policy, wherein the download path information indicates a high speed data transmission path made up of node servers.

The sending unit 63 is configured to send the data download path information calculated by the calculation unit 62 to the edge server.

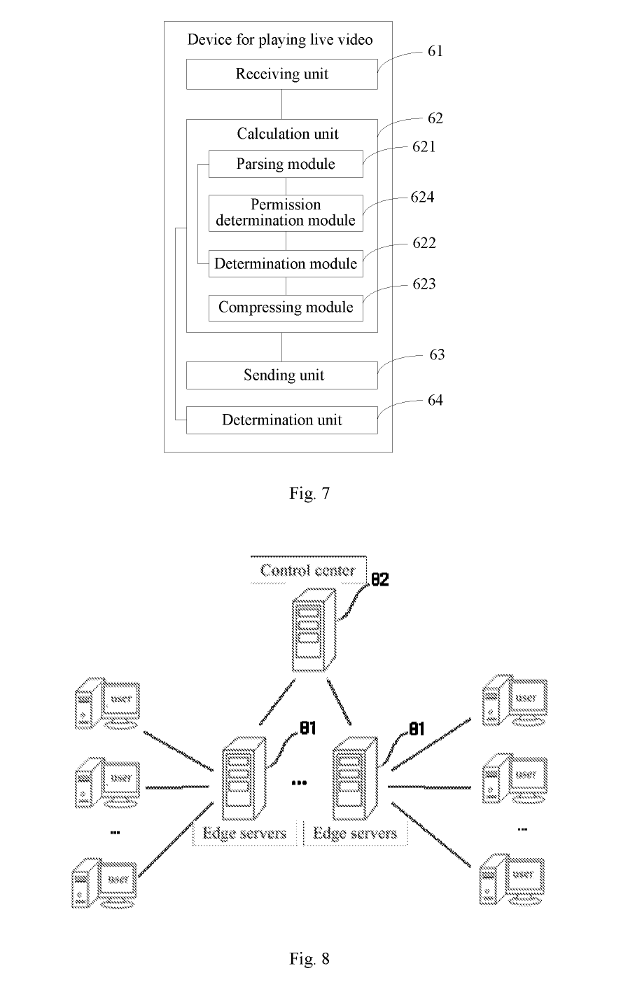

Further, as shown in FIG. 7, the calculation unit 62 can include a parsing module 621, a determination module 622 and a compression module 623.

The parsing module 621 is configured to parse the play request to obtain user information of the client and address information of the edge server.

The determination module 622 is configured to, according to the user information obtained by the parsing module 621 and the preset path configuration policy, determine a node address list indicating a data download path, wherein address information of respective node servers in the download path for transmitting live video data are listed in the node address list, an origin node address in the node address list is the address of a source server storing the live video in a live broadcasting platform, and an end node address is the address of the edge server.

The compression module 623 is configured to compress the node address list determined by the determination module 622 into the data download path information so that the data download path information is suitable for being sent to the edge server.

Further, as shown in FIG. 7, the calculation unit 62 can further include a permission determination module 624.

The permission determination module 624 is configured to determine a view permission of the client according to the user information obtained by the parsing module 624.

The determination module 622 is further configured to, if the permission determination module 624 determines that the client has a view permission, calculate the data download path information in response to the play request.

Further, as shown in FIG. 7, the device can further include a determination unit 64.

The determination unit 64 is configured to, before the data download path information is calculated in real time by the calculation unit 62 according to the preset path configuration policy in response to the play request, determine in the control center data transmission status of all node servers in a CDN system by keepalive packets to enable the control center to configure the high speed data transmission path.

Further, embodiments of the present disclosure provide a system for playing live video. As shown in FIG. 8, the system can include an edge server 81 including the device for playing live video as mentioned above, and a control center 82 including the device for playing live video as mentioned above.

The edge server 81 receives a live video play request from a client, sends the play request to the control center 82, obtains live video data from a live broadcasting platform according to data download path information returned by the control center 82, and sends the live video data to the client so that the client can play the live video.

The control center 82 receives the live video play request sent from the edge server 81, calculates in real time data download path information according to a preset path configuration policy in response to the play request, and sends the obtained data download path information to the edge server 81.

In view of the above, in the methods, devices and system for playing live video provided by embodiments of the present disclosure, an edge server receives a play request from a client requesting to view live video, and sends the request to a control center; the control center, in response to the play request, configures information of a path for downloading live video data according to the current status of the whole CDN system, and sends the data download path information back to the edge server; and the edge server obtains corresponding live video data from a live broadcasting platform along the path specified by the data download path information and forwards the live video data to the client for play. As compared with prior methods for playing live video, the data transmission path calculated by using the play methods in embodiments of the present disclosure is a dynamic path depending on the data transmission status of the whole CDN system, instead of a fixed one in the edge server. Thus, the technical solutions in the present disclosure can effectively avoid congested or failed nodes in the network, thereby making play of live video more fluently. Also, if policy amendments are needed for configuring paths, the policy adjustments only need to be performed in the control center, and the steps of amending path configuration files in respective edge servers can be omitted. As a result, the configuration procedure is simplified, and thereby the response efficiency of the path configuration can be improved.

It shall be noted that the functions of respective units or modules in the above devices for playing live video according to embodiments of the present disclosure can be realized by hardware processors.

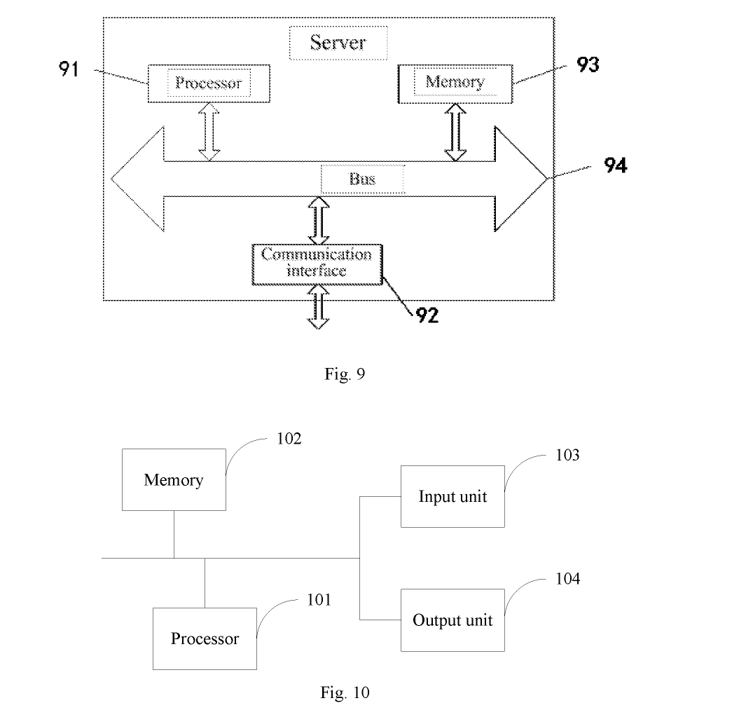

As an example, FIG. 9 is a block diagram showing a device for playing live video according to an embodiment of the present disclosure. In the embodiment, the device for playing live video is provided in a physical server which can include a processor 91, a communication interface 92, a memory 93 and a bus 94. The processor 91, the communication interface 92 and the memory 93 communicate with each other via the bus 94. The communication interface 92 may be used for information transmission between the server and a client. The processor 91 calls on logic instructions in the memory 93 to perform the following method: an edge server receiving a play request from a client requesting to view live video, wherein the edge server is a node server in a CDN system which provides data transmission service to the client; sending the play request to a control center, so that the control center configures data download path information according to the play request, wherein the control center is configured to monitor data transmission status of all node servers in the CDN system; receiving, from the control center, the data download path information indicating a data transmission path made up of node servers and calculated in real time by the control center according to a preset path configuration policy; obtaining live video data corresponding to the play request from a live broadcasting platform according to the data download path information; and sending the live video data to the client to enable the client to play the live video.

In addition, the logic instructions in the memory 93 may be implemented as software functional units which can be stored in a computer readable storage medium when sold or used as independent products. Based on such understanding, the essence of or a part of the technical solutions in the present disclosure (that is, the part making contributions over prior arts) may be embodied as software products. The computer software products may be stored in a storage medium including instructions which enable a computer device (for example, a personal computer, a server or a network device, and so on) to perform whole or a part of the steps in the methods according to various embodiments of the present disclosure. The above mentioned storage medium can include various mediums capable of storing program codes, for example, a USB flash drive, a mobile hard disk drive, a read only memory (ROM), a random access memory (RAM), a magnetic disk or an optical disk, and so on.

Further, an embodiment of the present disclosure further provides a non-transitory computer-readable storage medium storing executable instructions, which can be executed by an electronic device to perform any methods for playing live video mentioned by embodiments of the present disclosure.

FIG. 10 is a block diagram of an electronic device which is configured to perform the methods for playing live video according to an embodiment of the present disclosure. As shown in FIG. 10, the device includes: one or more processors 101 and memory 102. A processor 101 is showed in FIG. 10 for an example.

Device which is configured to perform the methods for playing live video can also include: input unit 103 and output unit 104.

Processor 101, memory 102, input unit 103 and output unit 104 can be connected by BUS or other methods, and BUS connecting is showed in FIG. 10 for an example.

Memory 102 can be used for storing non-transitory software program, non-transitory computer executable program and modules as a non-transitory computer-readable storage medium, such as corresponding program instructions/modules for the methods for playing live video mentioned by embodiments of the present disclosure (such as shown in FIG. 4, first receiving unit 41, sending unit 42, second receiving unit 43, obtaining unit 44). Processor 101 performs kinds of functions and playing live video of the electronic device by executing non-transitory software program, instructions and modules which are stored in memory 102, thereby realizes the methods for playing live video mentioned by embodiments of the present disclosure.

Memory 102 can include program storage area and data storage area, thereby the operating system and applications required by at least one function can be stored in program storage area and data created by using the device for playing live video can be stored in data storage area. Furthermore, memory 102 can include high speed Random-access memory (RAM) or non-volatile memory such as magnetic disk storage device, flash memory device or other non-volatile solid state storage devices. In some embodiments, memory 102 can include long-distance setup memories relative to processor 101, which can communicate with the device for playing live video by networks. The examples of said networks are including but not limited to Internet, Intranet, LAN, mobile Internet and their combinations.

Input unit 103 can be used to receive inputted number, character information and key signals causing user configures and function controls of the device for playing live video. Output unit 104 can include a display screen or a display device.

The said module or modules are stored in memory 102 and perform the methods for playing live video when executed by one or more processors 101.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for playing live video implemented by an edge server, comprising:
receiving a play request from a client requesting to view live video, wherein the edge server is a node server in a content delivery network (CDN) system which provides data transmission service to the client;
sending the play request to a control center, so that the control center configures data download path information according to the play request, wherein the control center is configured to monitor data transmission status of all node servers in the CDN system;
receiving, from the control center, the data download path information indicating a data transmission path made up of node servers and calculated in real time by the control center according to a preset path configuration policy;
obtaining live video data corresponding to the play request from a live broadcasting platform according to the data download path information; and
sending the live video data to the client to enable the client to play the live video.

2. The method according to claim 1, wherein sending the play request to the control center, comprises:
adding address information of the edge server into the play request to generate a download path request; and
sending the download path request to the control center.

3. The method according to claim 1, wherein receiving the data download path information from the control center, comprises:
obtaining the download path information configured by the control center according to the download path request; and
parsing the download path information to obtain a node address list in which address information of respective node servers in a path for transmitting the live video data are listed.

4. The method according to claim 3, wherein obtaining live video data corresponding to the play request from the live broadcasting platform according to the data download path information, comprises:
sending the download path information and the play request to the live broadcasting platform, so that the live broadcasting platform searches corresponding live video data according to the play request and transmits the live video data along the path configured in the download path information; and
receiving the live video data sent from the live broadcasting platform.

5. An electronic device, comprising:
at least one processor; and
a memory communicably connected with the at least one processor for storing instructions executable by the at least one processor, wherein execution of the instructions by the at least one processor causes the at least one processor to:
receive a play request from a client requesting to view live video, wherein the edge server is a node server in a CDN system which provides data transmission service to the client;
send the play request to a control center, so that the control center configures data download path information according to the play request, wherein the control center is configured to monitor data transmission status of all node servers in the CDN system;
receive, from the control center, the data download path information indicating a data transmission path made up of node servers and calculated in real time by the control center according to a preset path configuration policy;
obtain live video data corresponding to the play request from a live broadcasting platform according to the data download path information; and
send the obtained live video data to the client so that the client plays the live video.

6. The electronic device according to claim 5, wherein the instructions are executed to cause the at least one processor to:
add address information of the edge server into the play request to generate a download path request; and
send the download path request to the control center.

7. The electronic device according to claim 5, wherein the instructions are executed to cause the at least one processor to:
obtain the download path information configured by the control center according to the download path request; and
parse the download path information to obtain a node address list in which address information of respective node servers in a path for transmitting the live video data are listed.

8. The electronic device according to claim 7, wherein the instructions are executed to cause the at least one processor to:
send the download path information and the play request to the live broadcasting platform, so that the live broadcasting platform searches corresponding live video data according to the play request and transmits the live video data along the path configured in the download path information; and
receive the live video data sent from the live broadcasting platform.

9. An electronic device, comprising:
at least one processor; and
a memory communicably connected with the at least one processor for storing instructions executable by the at least one processor, wherein execution of the instructions by the at least one processor causes the at least one processor to:
receive a play request for playing live video sent from an edge server, wherein the play request is a live video play request sent from a client requesting to view the live video to the edge server;
in response to the play request, calculate in real time data download path information according to a preset path configuration policy, wherein the download path information indicates a data transmission path made up of node servers; and
send the calculated data download path information to the edge server.

10. The electronic device according to claim 9, wherein calculate in real time the data download path information according to the preset path configuration policy in response to the play request, comprises:
parse the play request to obtain user information of the client and address information of the edge server;
according to the user information and the preset path configuration policy, determine a node address list indicating a data download path, wherein address information of respective node servers in the download path for transmitting live video data are listed in the node address list, an origin node address in the node address list is the address of a source server storing the live video in a live broadcasting platform, and an end node address is the address of the edge server; and
compress the node address list into the data download path information so that the data download path information is suitable for being sent to the edge server.

11. The device according to claim 10, wherein after parsing the play request to obtain user information of the client and address information of the edge server, the instructions are executed to cause the at least one processor to:
determine a view permission of the client according to the user information; and
if the client has a view permission, calculate the data download path information in response to the play request.

12. The device according to claim 9, wherein before calculating in real time the data download path information according to the preset path configuration policy in response to the play request, the instructions are executed to cause the at least one processor to:
determine data transmission status of all node servers in a CDN system by keepalive packets to enable the control center to configure the data transmission path.
